(19) United States
(12) Patent Application Publication
(10) Pub. No.: US 2016/0116219 A1
(43) Pub. Date: Apr. 28, 2016

(54) HEAT EXCHANGER, METHOD FOR MAINTAINING, PRODUCING AND OPERATING A HEAT EXCHANGER, POWER PLANT AND METHOD FOR GENERATING ELECTRIC POWER

(71) Applicant: LINDE AKTIENGESELLSCHAFT, München (DE)

(72) Inventors: Christoph Seeholzer, Trostberg (DE); Andrew Lochbrunner, Oberhof (CH); Hubert Köpf, Poing (DE); Konrad Braun, Lenggries (DE); Heiko Schuster, Moritzburg (DE)

(21) Appl. No.: 14/889,869

(22) PCT Filed: May 20, 2014
(86) PCT No.: PCT/EP2014/001362

§ 371 Date: Nov. 9, 2015

(30) Foreign Application Priority Data
May 21, 2013 (EP) 13002660.2

(51) Int. Cl. F28D 7/02; B23P 15/26; F28D 7/06

(52) U.S. Cl. CPC F28D 7/02; F28D 7/06; B23P 15/26

(57) ABSTRACT

A heat exchanger, a method for maintaining, for producing and for operating a heat exchanger, a power plant, and a method for generating electric power. The heat exchanger has a pipe system divided into a first pipe bundle and a second, replaceable pipe bundle. The first pipe bundle operates for a first time period in a first temperature range, and the second pipe bundle operates for a second time period shorter than the first time period and in a second temperature range higher than the first temperature range. The first temperature range has a maximum temperature lower than the temperature at which creep of the material of the first pipe bundle begins, and the second temperature range has a maximum temperature as high or higher than the temperature at which creep of the material of the second pipe bundle begins.

The invention relates to a heat exchanger, a method for maintaining a heat exchanger and a method for producing a heal exchanger, a method for operating a heat exchanger, a power plant, in particular a solar thermal power plant, and a method for generating electric power.

The heat exchanger according to the invention thus serves for the indirect exchange of heat between a first heat transfer medium and a second heat transfer medium. The respective heat transfer medium can in that context be a liquid, gaseous or supercritical medium, which absorbs a quantity of heat within or without a power plant process and again gives it off, also within or without a power plant process. In that context, the heat transfer medium can also serve to take up thermal energy as the working medium in the power plant process in order to supply this energy to a device in which the thermal energy is converted into mechanical work.

It is known that electric power can be generated from solar energy in solar thermal power plants, in a thermodynamic circular process. To that end, WO 2011/077248 A2 discloses a device for generating electric power using solar energy. In this context, heat is transferred from a first heat transfer medium to a second heat transfer medium and the heat of the second heat transfer medium is at least partially converted into electric power.

Usually, in solar thermal power plants, steam is generated from a working medium such as water or ammonia and is used to drive a steam turbine which is mechanically connected to a generator for generating the electric current. In that context, heat can be supplied to the working medium by means of solar radiation or also indirectly by means of a heat transfer medium such as thermal oil or a salt melt. This heat transfer medium can in turn also have been heated by means of solar energy. A directly or indirectly heated heat transfer medium can serve as an intermediate store in times in which there is more demand for electric power than can be satisfied by the conversion of solar energy.

Salt melts, typically eutectic mixtures of KNO₃ and NaNO₃, can in particular be used for heat storage. These salt melts can be heated to temperatures of 250° C. to 400° C. or 600° C., as described above directly or also by means of another heat transfer medium such as thermal oil, and can be stored in flat-bottomed tanks. Alternatively, or after storage, the heat of the salt melt can be given off either directly or indirectly to a working medium.

For transferring the heat between a salt melt or another heat transfer medium and a further heat transfer medium, use is preferably made of tube bundle heat exchangers. For heating a salt melt as heat transfer medium for solar applications, the hot end of the tube bundles of such a tube bundle heat exchanger is subjected to temperatures of up to 620° C.

FR 2501832 A1 discloses a heat exchanger for the indirect exchange of heat between a first heat transfer medium and a second heat transfer medium. This heat exchanger comprises a tube system for accommodating a heat transfer medium which is divided into a first tube bundle and a second tube bundle. The second tube bundle is designed such that it can be replaced and can be fluidically separated from the first tube bundle.

DE 3007610 A1, US 2012/211206 A1 and GB 184443 A disclose bundle heat exchangers having tube bundles which are operated in different temperature ranges. In that context, the second tube bundle is configured as a U-tube bundle and/or with a smaller volume than the first tube bundle.

A tube heat exchanger with U-tube bundle can also be found in CH 271219 A.

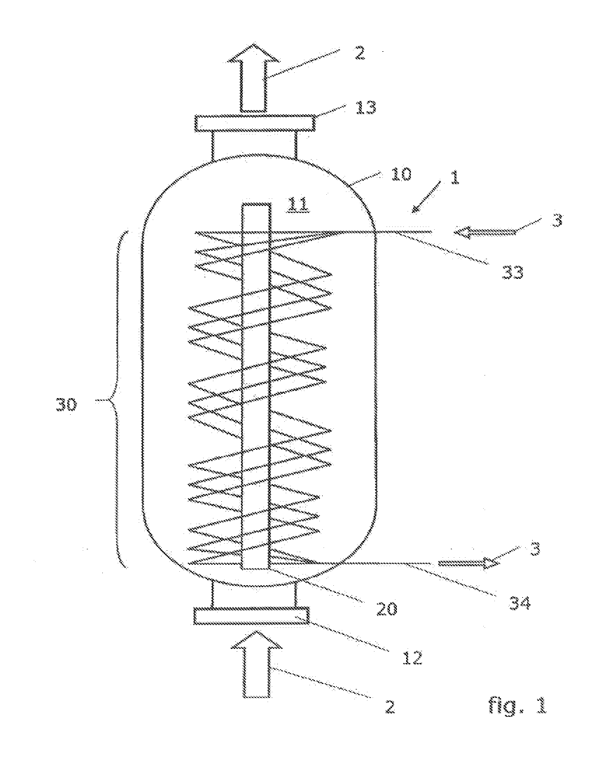

Furthermore, a conventional tube bundle heat exchanger is shown in FIG. 1. This tube bundle heat exchanger is referred to in the following as heat exchanger 1. The heat exchanger 1 comprises a jacket 10 which encloses a jacket space 11. In the jacket space 11 there is arranged a tube system 30, wherein the individual tubes of the tube system 30 are arranged in a bundle which is wound helically or in the manner of a screw thread around a core tube 20. An inlet pipe 12 is arranged on the underside of the jacket 10 and an outlet pipe 13 is arranged on the upper side of the jacket 10. A first heat transfer medium 2 enters the jacket space 11 through the inlet pipe 12 and passes through the core tube 20 and/or through the jacket space 11, to the outlet pipe 13, by which it is conveyed further.

A second heat transfer medium 3 flows through a first inlet device 33 into the tube system 30, where it splits into the individual tubes and is evacuated through the first outlet device 34. The relatively large surface of the tube system 30 in the jacket space 11 results in an efficient exchange of heat between the first heat transfer medium 2 and the second heat transfer medium 3. Heat can thus be transferred from the first heat transfer medium 2 to the second heat transfer medium 3, or from the second heat transfer medium 3 to the first heat transfer medium 2.

When a salt melt is used as the first heat transfer medium 2, this has, on entering the inlet pipe 12, for example a temperature of 270° C. and, on exiting the outlet pipe 13, a temperature of 580° C. If, at the same time, water steam is used as the second heat transfer medium 3, the latter is at a temperature of 620° C. on entering the first inlet device 33 and is at a temperature of 290° C. on exiting the first outlet device 34. It is obvious that a large quantity of heat has been transferred from the steam as second heat transfer medium 3 to the salt melt as first heat transfer medium 2.

Because of the high thermal load on the tube system, the latter must be designed with high strength, in particular with high creep strength. In order to fulfill the required strength values, stainless steels are often used for this purpose for the tube system 30. Such stainless steels must be designed for creep strength at a thermal load of more than 593° C. (according to the ASME—standard of the American Society of Mechanical Engineers) or at a thermal load of 585° C. (according to AD-2000 specifications which give the methods for calculation or evaluation; or according to VDTÜV material datasheets which give the temperatures and the respective creep strengths with respect to the time under load).

In order not to exceed the permissible creep stress, such components must often be inspected or replaced after a certain number of load cycles and/or after a certain service life.

Creep, which over time leads to reduced strength, refers to a plastic deformation of a material which is time- and temperature-dependent and is caused by a load.

Creep deformation is then dependent on the respective homologous temperature, since materials having a high melting point have a high bond energy. The homologous temperature is calculated from the melting point of the respective material, incorporating certain factors. In the case of iron, the homologous temperature is for example approximately 450° C. That means that components of a heat exchanger, which are subject to high thermal load, must be configured according to their creep behavior, as defined by their respective creep strength. This requires the use of relatively expensive materials in the heat exchanger. It must however be assumed that, in spite of the components of a heat exchanger, in particular of a tube bundle, subject to high thermal load being configured accordingly, it is nonetheless necessary to perform maintenance and/or to replace these components at relatively short time intervals. However, in particular in the case of very large and powerful heat exchangers, such maintenance or repair is very cost-intensive and time-consuming.

U.S. Pat. No. 3,841,271 A1 describes a heat exchanger which has multiple tube bundles arranged in parallel. These tube bundles are attached to the casing by means of screws and welded connections. All of the tube bundles are then subjected to the same temperatures.

The present invention is based on the object of providing a heat exchanger and a method for producing or maintaining and for operating a heat exchanger which permits the transfer of heat cost-effectively with simple construction and with low manufacturing and/or maintenance costs. Further aspects of the object are the creation of a power plant and a method for generating electric power.

This object is achieved with the heat exchanger named in claim 1, with the method, named in claim 8, for producing or maintaining a heat exchanger according to the invention, with the method, named in claim 10, for operating a heat exchanger according to the invention, with the power plant named in claim 13 and the method, named in claim 14, for generating electric power. Advantageous embodiments of the heat exchanger according to the invention are indicated in subclaims 2 to 7. An advantageous embodiment of the method for producing or maintaining a heat exchanger according to the invention is indicated in subclaim 9. An advantageous embodiment of the method for operating a heat exchanger according to the invention is indicated in claim 11. An advantageous embodiment of the method for generating electric power is indicated in subclaim 15.

The invention provides a heat exchanger for the indirect exchange of heat between a first heat transfer medium and a second heat transfer medium, comprising a tube system for accommodating a heat transfer medium, wherein the tube system is or can be divided at least into a first tube bundle and a second, replaceable tube bundle. It is provided that the first tube bundle is configured for operation over a first time period in a first temperature range and the second tube bundle is configured for operation over a second time period in a second temperature range, and the temperatures of the second temperature range are higher than the temperatures of the first temperature range and the second time period is shorter than the first time period. The first temperature range is bounded by a maximum temperature which is lower than the temperature of the material of the first tube bundle above which, for the given mechanical load on the first tube bundle, the material of the first tube bundle begins to creep. Alternatively or in addition, the second temperature range is bounded by a maximum temperature which is equal to or higher than the temperature of the material of the second tube bundle above which, for the given mechanical load on the second tube bundle, the material of the second tube bundle begins to creep.

In that context, the first heat transfer medium can in particular be a salt melt or also water, water steam, ammonia, supercritical carbon dioxide or a thermal oil, which flows through the jacket space of the heat exchanger. The second heat transfer medium can in particular be steam or hot water. The second heat transfer medium flows through the tube system.

In a preferred embodiment, the two tube bundles are connected to one another by means of one or more releasable mechanical connection elements at a fluidic interface such as a flange. In that context, the second tube bundle is configured such that it can be removed from the first tube bundle with plannable operations or movements which are to be carried out manually or automatically, and can accordingly be replaced with another tube bundle.

It is alternatively provided that the same second tube bundle, which has been reconditioned and/or maintained after removal from the heat exchanger, is once again installed in its earlier position in the heat exchanger. This has the advantage that, in particular when the permissible creep stress is reached, it is not necessary to replace the entire tube system but only the second tube bundle, resulting in lower maintenance costs and shorter maintenance times as well as lower material costs.

The second tube bundle is configured for operating temperatures which are higher than the operating temperatures for which the first tube bundle is configured. In that context, it is also possible for the respective temperature ranges assigned to the tube bundles to overlap slightly, it being merely necessary that the average temperature of the second temperature range be higher than the average temperature of the first temperature range. Preferably, the respective tube bundle is configured such that, within the respective planned operating period and/or operating temperature, the actual creep stress in the tube bundle does not exceed a permissible creep stress.

It can thus be provided that both tube bundles are made of essentially the same material and/or with the same wall thickness of the respective tubes or the same number of tubes. Due to the high thermal load on the second tube bundle, the service life of the latter is shorter than that of the first tube bundle since, in the second tube bundle, the permissible creep stress is reached earlier than in the first tube bundle.

The temperature of the material above which, for the given mechanical load, the material of the first tube bundle begins to creep can also be termed the homologous temperature or the minimum creep temperature.

Calculation of the respective permissible creep stress or of the creep strength will be known to a person skilled in the art.

The permissible creep strength can be calculated for example according to ASME, relating to ASME section II/D and for AD materials according to the VDTÜV material datasheets.

That means that certain technical properties of the tube bundles, such as their material, wall thicknesses, shape and/or size and their attachment and vibration tendency, and the internal stresses resulting therefrom, are used to configure these tube bundles such that a respective tube bundle operates in its assigned temperature range over its assigned time period, namely the first tube bundle operates in a first, low temperature range over a relatively long time period and the second tube bundle operates in a second, higher temperature range over a relatively short time period.

Preferably, the first tube bundle and/or the second tube bundle are made of stainless steel, use being made advantageously in particular of the material TP304 according to ASME or 1.4301 according to AD specification/DIN. For nickel-based alloys, the material is preferably Inconel 625 and for carbon steels, the material P91 can be used for sheets and T91 for tubes.

However, it is also possible to use carbon steels to create low-cost tube bundles.

In particular, the heat exchanger can be a helically coiled heat exchanger as are used for example in various large-scale technical processes such as methanol scrubbing, natural gas liquefaction or ethylene production. Such a helically coiled heat exchanger comprises multiple tubes which are coiled around a central core tube in multiple layers. Both the tubes and the core tube are surrounded by a jacket which thus bounds the jacket space in which both the tube bundles and the core tube are located. The tubes are usually brought together in one or more bundles in perforated plates at the ends of the heat exchanger and are connected to inlets and outlets in the jacket of the heat exchanger. The tubes of the heat exchanger can be charged with one or more separate heat transfer medium flows. The heat transfer medium flowing through the jacket tube exchanges heat with the heat transfer medium in the tube system.

Such a helically coiled heat exchanger can be constructed such that both the jacket and the tubes are self-emptying. That makes it simpler to supply and remove certain heat transfer media such as for example salt melts. This also ensures a self-emptying quality since solidification of the salt melt in the heat exchanger (if the temperature drops below the melting point) can result in destruction of the heat exchanger.

In addition, a heat exchanger of this design is relatively robust with respect to changes in temperature load which take place at large temperature intervals.

The first temperature range, which serves for configuring the tube bundles, is preferably bounded by a maximum temperature of 550° C. to 600° C. and the second temperature range is bounded by a minimum temperature of 560° C. to 600° C. In that context, a maximum temperature for the first temperature range between 570° C. and 590° C., in particular 580° C., and a minimum temperature for the second temperature range between 570° C. and 590° C., in particular 580° C. have proven particularly suitable.

In a further preferred embodiment, it is provided that the first temperature range is bounded by a minimum temperature of 270° C. to 310° C. and the second temperature range is bounded by a maximum temperature of 600° C. to 640° C. In that context, the first temperature range is preferably bounded by a minimum temperature of 280° C. to 300° C., in particular 290° C., and the second temperature range is preferably bounded by a maximum temperature of 610° C. to 630° C., in particular 620° C.

If a carbon steel is used, the first temperature range should be bounded by a maximum temperature of 400° C. to 450° C., and the second temperature range should be bounded by a minimum temperature of 400° C. to 450° C.

The specified temperature ranges serve for the concrete configuration of the tube bundles and thus for determining the concrete technical or design features.

In an expedient configuration of the heat exchanger according to the invention, it is provided that the second tube bundle has a smaller volume than the first tube bundle. This has the advantage that the second tube bundle can be replaced easily and quickly and with low material costs.

Additionally or alternatively, it can be provided that the second tube bundle is a U-tube bundle. Such a tube bundle has the advantage of simple installation and removal. It can also be provided that the entire tube system is integrated within the jacket space of the heat exchanger, wherein the second tube bundle is connected to a jacket segment and this jacket segment is also replaced together with the second tube bundle when the latter is replaced. In an alternative embodiment, the jacket has an opening which can be uncovered and through which the second tube bundle can be replaced. In particular, the tube system can be configured such that the second tube bundle is fluidically separate from the first tube bundle.

It is alternatively provided that the first tube bundle and the second tube bundle are fluidically coupled together. In the case of fluidic coupling, one expedient embodiment provides a device for severing the flow path between the first and second tube bundles.

In this case, removing or replacing the second tube bundle involves severing the tube system at the above-mentioned fluidic interface.

A further aspect of the present invention is a method for maintaining a heat exchanger according to the invention, in which a functionally impaired second tube bundle is replaced with a functional second tube bundle. A functionally impaired second tube bundle can in that context be a tube bundle which is already used and has been worn out, primarily because of the high thermal load, in which case there is a risk that the permissible creep stress will be exceeded under normal operating conditions of the heat exchanger. Such a second tube bundle is replaced with a new or reconditioned or at least functional tube bundle. This has the advantage that, in the event of heat-induced wear phenomena, only that tube bundle which is subjected to higher loads need be replaced. It is accordingly possible to repair and/or maintain the heat exchanger with low expenditure in terms of materials, time and personnel.

In the embodiment of the heat exchanger in which both tube bundles are fluidically connected to one another, the method according to the invention for maintaining the heat exchanger provides in particular that, when replacing the second tube bundle, a flow path between the first tube bundle and the second tube bundle is severed.

Similarly, there is proposed a method for producing a heat exchanger according to the invention, in which a tube system for accommodating a heat transfer medium is installed, wherein a first tube bundle and a second, replaceable tube bundle are installed as constituent parts of the tube system, wherein the first tube bundle is configured for operation over a first time period in a first temperature range and the second tube bundle is configured for operation over a second time period in a second temperature range, and the temperatures of the second temperature range are higher than the temperatures of the first temperature range and the second time period is shorter than the first time period. In that context, the first temperature range is bounded by a maximum temperature which is lower than the temperature of the material of the first tube bundle above which, for the given mechanical load on the first tube bundle, the material of the first tube bundle begins to creep. Alternatively or in addition, the second temperature range is bounded by a maximum temperature which is equal to or higher than the temperature of the material of the second tube bundle above which, for the given mechanical load on the second tube bundle, the material of the second tube bundle begins to creep. That means that the first tube bundle and the second tube bundle are different, namely in terms of their configurations for certain temperature ranges and operating periods.

Here, too, the first temperature range is preferably bounded by a maximum temperature of 550° C. to 600° C. and the second temperature range is bounded by a minimum temperature of 560° C. to 600° C., and the first temperature range is bounded by a minimum temperature of 270° C. to 310° C. and the second temperature range is bounded by a maximum temperature of 600° C. to 640° C.

A further aspect of the present invention is a method for operating a heat exchanger according to the invention for the indirect exchange of heat between a first heat transfer medium and a second heat transfer medium, comprising a tube system for accommodating a heat transfer medium, which is or can be divided at least into a first tube bundle and a second, replaceable tube bundle, wherein during operation of the heat exchanger the first tube bundle is operated over a first time period in a first temperature range and the second tube bundle is operated over a second time period in a second temperature range, wherein the temperatures of the second temperature range are higher than the temperatures of the first temperature range and the second time period is shorter than the first time period.

It is provided in that context that the first tube bundle is operated in a first temperature range bounded by a maximum temperature which is lower than the temperature of the material of the first tube bundle above which, for the given mechanical load on the first tube bundle, the material of the first tube bundle begins to creep, and the second tube bundle is operated in a second temperature range bounded by a maximum temperature which is equal to or higher than the temperature of the material of the second tube bundle above which, for the given mechanical load on the second tube bundle, the material of the second tube bundle begins to creep.

In particular, the first tube bundle can be operated in a first temperature range which is bounded by a minimum temperature of 270° C. to 310° C. and a maximum temperature of 550° C. to 600° C., and the second tube bundle can be operated in a second temperature range which is bounded by a minimum temperature of 560° C. to 600° C. and a maximum temperature of 600° C. to 640° C. In that context, it is preferable for the first temperature range to be bounded by a minimum temperature between 280° C. and 300° C., in particular 290° C., and a maximum temperature between 570° C. and 590° C., in particular 580° C. The second temperature range is preferably bounded by a minimum temperature between 570° C. and 590° C., in particular 580° C., and by a maximum temperature of 610° C. to 630° C., in particular 620° C. The first tube bundle is then operated for a first time period and the second tube bundle is operated for a second time period. Due to the different thermal loads on the individual tube bundles, the first time period is longer than the second time period, such that the first tube bundle is operated for a longer time than the second tube bundle.

For the purpose of replacing the second tube bundle, it is preferably provided that at least the heat exchange process between the first heat transfer medium and the second heat transfer medium, carried out by means of the second tube bundle, is stopped and the second tube bundle is replaced. In a simple embodiment of the method, this means that the operation of the entire heat exchanger is stopped and the second tube bundle is replaced. In an alternative embodiment, this means that the operation of the first tube bundle is maintained and the operation of the second tube bundle is stopped and the second tube bundle is replaced.

After the second tube bundle has been replaced, the heat exchange process between the first heat transfer medium and the second heat transfer medium can be resumed by means of the new second tube bundle. This means that the second tube bundle is replaced during the operating period or service life of the heat exchanger.

The invention also relates to a power plant, in particular to a solar thermal power plant, which serves for generating electric power and comprises a heat exchanger according to the invention for the indirect exchange of heat between a first heat transfer medium and a second heat transfer medium. Depending on the required power, it can be necessary, in order to transfer a defined quantity of heat between the heat transfer media, to operate multiple heat exchangers according to the invention in parallel. The heat exchanger according to the invention can advantageously be used in a solar thermal power plant since the fact that the second tube bundle is replaceable ensures the operability of the heat exchanger and thus can reduce the risk of the power plant breaking down due to wear.

The heat transfer media used in this solar thermal power plant may be the fluids indicated in the introduction for clarification of the prior art.

The present invention is complemented by a method for generating electric power, in which the inventive method for operating a heat exchanger is carried out, heat being transferred from a first heat transfer medium to a second heat transfer medium and the heat of the second heat transfer medium being at least partially converted into electric power. In that context, this conversion can in particular take place by using the heat to generate steam, using the mechanical energy of the latter and converting the mechanical energy into electric power, for example in a turbine. That means that in this case the heat of the second heat transfer medium is used indirectly to generate electric power.

In a further embodiment of this method, it can be provided that the heat from the second heat transfer medium is transferred to a further heat transfer medium whose heat is at least partially converted into electric power. In that context, this further heat transfer medium can once again be the first heat transfer medium, such that the second heat transfer medium merely serves as a reservoir. In this case, the first heat transfer medium is preferably water or steam, and the second heat transfer medium is a salt melt.

Further details and advantages of the invention will be explained by means of the following description of the figures for an exemplary embodiment, with reference to the figures, in which:

FIG. 1 is a section view of a conventional heat exchanger,

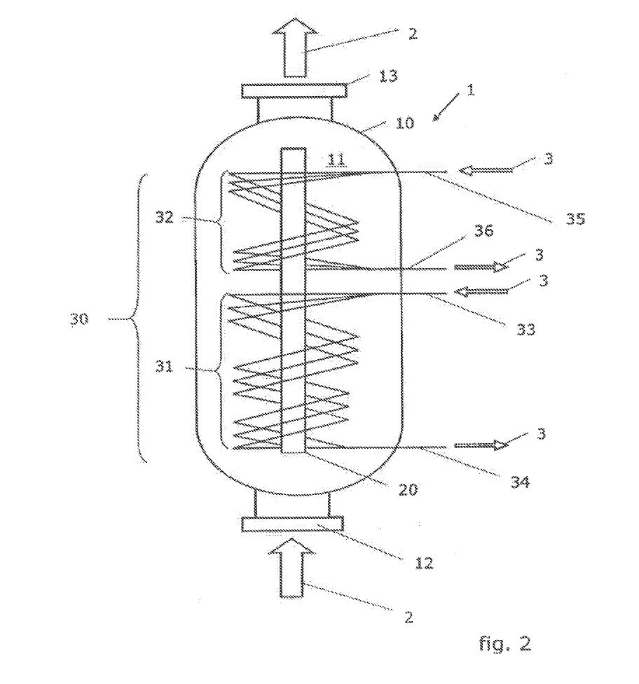

FIG. 2 is a section view of an inventive heat exchanger.

The conventional heat exchanger, as represented in FIG. 1, has already been discussed for the purpose of clarifying the prior art.

An inventive heat exchanger 1 is represented in FIG. 2. This heat exchanger 1 also comprises a jacket 10, which encloses a jacket space 11. The core tube 20 is arranged in the jacket space 11; the tube system 30 extends helically or in the form of a screw thread around the core tube. The tube system 30 is divided into a first tube bundle 31 in the lower part of the heat exchanger 1 and a second tube bundle 32 in the upper part of the heat exchanger 1. An inlet pipe 12 for an inflowing volume flow of the first heat transfer medium 2 is arranged at the bottom of the jacket 10. An outlet pipe 13 is arranged on top of the jacket 10 in order to carry away, from the jacket space 11, the volume flow of the first heat transfer medium 2. After entering through the inlet pipe 12, the first heat transfer medium 2—which can for example be a salt melt or also water or water steam or ammonia, supercritical carbon dioxide or a thermal oil—flows through the jacket space 11 and/or the core tube 20 and flows out through the outlet pipe 13.

The second heat transfer medium 3, which can for example be steam or hot water, flows into the first tube bundle 31 through a first inlet device 33 and leaves the first tube bundle 31 through a first outlet device 34. The second heat transfer medium 3 also flows into the second tube bundle 32 through a second inlet device 35 and leaves the second tube bundle 32 through a second outlet device 36. In that context, the temperature of the second heat transfer medium 3 on entering the first tube bundle 31 at the first inlet device 33 is approximately 580° C. At the first outlet device 34 of the first tube bundle 31, its temperature is approximately 290° C.

The temperature of the second heat transfer medium 3 on flowing into the second tube bundle 32 at the second inlet device 35 is approximately 620° C., and at the second outlet device 36 of the second tube bundle 32 its temperature is approximately 580° C.

In the shown variant of the inventive heat exchanger, the first tube bundle 31 and the second tube bundle 32 are fluidically decoupled from one another such that it is not necessary to sever a flow path between the two tube bundles 31, 32.

The separate arrangement of the second tube bundle allows it to be removed simply, quickly and cost-effectively from the first tube bundle 31 and replaced, such that it is possible to minimize downtime of the heat exchanger 1 due to maintenance. In that context, the second tube bundle is configured for operation in the indicated higher temperature range, but for a shorter operating period since the thermal load is higher and accordingly the permissible creep stress is reached earlier.

List of reference signs

| | |
|---|---|
| Heat exchanger | 1 |
| First heat transfer medium | 2 |
| Second heat transfer medium | 3 |
| Jacket | 10 |
| Jacket space | 11 |
| Inlet pipe | 12 |
| Outlet pipe | 13 |
| Core tube | 20 |
| Tube system | 30 |
| First tube bundle | 31 |
| Second tube bundle | 32 |
| First inlet device | 33 |
| First outlet device | 34 |
| Second inlet device | 35 |
| Second outlet device | 36 |

1. A heat exchanger for the indirect exchange of heat between a first heat transfer medium and a second heat transfer medium, comprising a tube system for accommodating a heat transfer medium, which is divided at least into a first tube bundle and a second, replaceable tube bundle, wherein the first tube bundle is configured for operation over a first time period in a first temperature range and the second tube bundle is configured for operation over a second time period in a second temperature range, and the temperatures of the second temperature range are higher than the temperatures of the first temperature range and the second time period is shorter than the first time period, characterized in that the first temperature range is bounded by a maximum temperature which is lower than the temperature of the material of the first tube bundle above which, for the given mechanical load on the first tube bundle, the material of the first tube bundle begins to creep, and that the second temperature range is bounded by a maximum temperature which is equal to or higher than the temperature of the material of the second tube bundle above which, for the given mechanical load on the second tube bundle, the material of the second tube bundle begins to creep.

2. The heat exchanger as claimed in claim 1, characterized in that the first temperature range is bounded by a maximum temperature of 550° C. to 600° C. and the second temperature range is bounded by a minimum temperature of 560° C. to 600° C.

3. The heat exchanger as claimed in claim 1, characterized in that the first temperature range is bounded by a minimum temperature of 270° C. to 310° C. and the second temperature range is bounded by a maximum temperature of 600° C. to 640° C.

4. The heat exchanger as claimed in claim 1, characterized in that the second tube bundle has a smaller volume than the first tube bundle.

5. The heat exchanger as claimed in claim 1, characterized in that the second tube bundle is a U-tube bundle.

6. The heat exchanger as claimed in claim 1, characterized in that the second tube bundle is fluidically separate from the first tube bundle.

7. A method for maintaining a heat exchanger comprising a tube system for accommodating a heat transfer medium, which is divided at least into a first tube bundle and a second replaceable tube bundle, wherein the first tube bundle is configured for operation over a first time period in a first temperature range and the second tube bundle is configured for operation over a second time period in a second temperature range, and the temperatures of the second temperature range are higher than the temperatures of the first temperature range and the second time period is shorter than the first time period, the first temperature range is bounded by a maximum temperature, which is lower than the temperature of the material of the first tube bundle above which, for the given mechanical load on the first tube bundle, the material of the first tube bundle begins to creep, and that the second temperature range is bounded by a maximum temperature which is equal to or higher than the temperature of the material of the second tube bundle above which for the given mechanical load on the second tube bundle, the material of the second tube bundle begins to creep, the method comprising replacing a functionally impaired second tube bundle with a functional second tube bundle.

8. The method for maintaining a heat exchanger as claimed in claim 7, characterized in that, when replacing the second tube bundle, a flow path between the first tube bundle and the second tube bundle is severed.

9. A method for producing a heat exchanger comprising installing a tube system for accommodating a heat transfer medium, the tube system having a first tube bundle and a second, replaceable tube bundle as constituent parts of the tube system,
wherein the first tube bundle is configured for operation over a first time period in a first temperature range and the second tube bundle is configured for operation over a second time period in a second temperature range,
and the temperatures of the second temperature range are higher than the temperatures of the first temperature range and the second time period is shorter than the first time period,
and wherein the first temperature range is bounded by a maximum temperature which is lower than the temperature of the material of the first tube bundle above which, for the given mechanical load on the first tube bundle, the material of the first tube bundle begins to creep, and the second temperature range is bounded by a maximum temperature which is equal to or higher than the temperature of the material of the second tube bundle above which, for the given mechanical load on the second tube bundle, the material of the second tube bundle begins to creep.

10. A method for operating a heat exchanger for the indirect exchange of heat between a first heat transfer medium and a second heat transfer medium, the heat exchanger comprising a tube system for accommodating a heat transfer medium, which is divided at least into a first tube bundle and a second, replaceable tube bundle, wherein the first tube bundle is operated over a first time period in a first temperature range and the second tube bundle is operated over a second time period in a second temperature range, wherein the temperatures of the second temperature range are higher than the temperatures of the first temperature range and the second time period is shorter than the first time period,
characterized in that the first tube bundle is operated in a first temperature range bounded by a maximum temperature which is lower than the temperature of the material of the first tube bundle above which, for the given mechanical load on the first tube bundle, the material of the first tube bundle begins to creep, and the second tube bundle is operated in a second temperature range bounded by a maximum temperature which is equal to or higher than the temperature of the material of the second tube bundle above which, for the given mechanical load on the second tube bundle, the material of the second tube bundle begins to creep.

11. The method for operating a heat exchanger as claimed in claim 10, characterized in that the first temperature range is bounded by a maximum temperature of 550° C. to 600° C. and the second temperature range is bounded by a minimum temperature of 560° C. to 600° C.

12. The method for operating a heat exchanger as claimed in claim 10, characterized in that the first temperature range is bounded by a minimum temperature of 270° C. to 310° C. and the second temperature range is bounded by a maximum temperature of 600° C. to 640° C.

13. The method for operating a heat exchanger as claimed in claim 10, characterized in that at least the heat exchange process between the first heat transfer medium and the second heat transfer medium, carried out by means of the second tube bundle, is stopped and the second tube bundle is replaced.

14. A power plant for generating electric power, comprising a heat exchanger for the indirect exchange of heat between a first heat transfer medium and a second heat transfer medium the heat exchanger comprising a tube system for accommodating the first and second heat transfer medium, which is divided at least into a first tube bundle and a second, replaceable tube bundle, wherein the first tube bundle is configured for operation over a first time period in a first temperature range and the second tube bundle is configured for operation over a second time period in a second temperature range, and the temperatures of the second temperature range are higher than the temperatures of the first temperature range and the second time period is shorter than the first time period, the first temperature range is bounded by a maximum temperature which is lower than the temperature of the material of the first tube bundle above which, for the given mechanical load on the first tube bundle, the material of the first tube bundle begins to creep, and that the second temperature range is bounded by a maximum temperature which is equal to or higher than the temperature of the material of the second tube bundle above which, for the given mechanical load on the second tube bundle, the material of the second tube bundle begins to creep.

15. A method for generating electric power, by operating a heat exchanger for the indirect exchange of heat between a first heat transfer medium and a second heat transfer medium, the heat exchanger comprising a tube system for accommodating a heat transfer medium, which is divided at least into a first tube bundle and a second, replaceable tube bundle, wherein the first tube bundle is operated over a first time period in a first temperature range and the second tube bundle is operated over a second time period in a second temperature range, wherein the temperatures of the second temperature range are higher than the temperatures of the first temperature range and the second time period is shorter than the first time period, wherein the first tube bundle is operated in a first temperature range bounded by a maximum temperature which is lower than the temperature of the material of the first tube bundle above which, for the given mechanical load on the first tube bundle, the material of the first tube bundle begins to creep, and the second tube bundle is operated in a second temperature range bounded by a maximum temperature which is equal to or higher than the temperature of the material of the second tube bundle above which, for the given mechanical load on the second tube bundle, the material of the second tube bundle begins to creep so that heat is transferred from the first heat transfer medium to the second heat transfer medium and the heat of the second heat transfer medium is at least partially converted into electric power.

16. The method for generating electric power as claimed in claim 15, in which the heat from the second heat transfer medium is transferred to a further heat transfer medium whose heat is at least partially converted into electric power.

17. The power plant as claimed in claim 14, wherein the power plant is a solar thermal power plant.
